(19) United States
(12) Patent Application Publication
(10) Pub. No.: US 2004/0130730 A1
(43) Pub. Date: Jul. 8, 2004

(54) Fast 3D height measurement method and system

(76) Inventors: Michel Cantin, Brossard (CA); Alexandre Nikitine, Montreal (CA); Benoit Quirion, Boucherville (CA)

Correspondence Address: OGILVY RENAULT, 1981 MCGILL COLLEGE AVENUE, SUITE 1600, MONTREAL, QC, H3A2Y3, CA

(21) Appl. No.: 10/717,191

(22) Filed: Nov. 20, 2003

Related U.S. Application Data
(60) Provisional application No. 60/427,966, filed on Nov. 21, 2002.

(51) Int. Cl. G01B 11/24

(52) U.S. Cl. 356/604

(57) ABSTRACT

The present invention provides a Fast Moiré Interferometry (FMI) method and system for measuring the dimensions of a 3D object using only two images thereof. The method and the system perform the height mapping of the object or the height mapping of a portion of the object. The present invention can be used to assess the quality of the surface of an object that is under inspection. It can also be used to evaluate the volume of the object under inspection.

### FIELD OF THE INVENTION

The present invention relates to measurement systems and methods. More specially, the present invention is concerned with a fast 3D height measurement system and method based on the FMI method.

### BACKGROUND OF THE INVENTION

The use of interferometric methods for three-dimensional inspection of an object or to measure the variations of height (relief of an object is well known. These methods generally consist in generating an interferometric image (or interferogram) to obtain the relief of the object. The interferometric image generally includes a series of black and white fringes.

In “classic interferometric methods”, which require the use of a laser to generate the interferometric pattern, the wavelength of the laser and the configuration of the measuring assembly generally determine the period of the resulting interferogram. Classic interferometry methods are generally used in the visible spectrum to measure height variations in the order of the micron. However, there has been difficulty in using such a method to measure height variations on a surface showing variations in the order of 0.5-1 mm when they are implemented in the visible spectrum. Indeed, the density of the black and white fringes of the resulting interferogram increases, causing the analysis to be tedious. Another drawback of classic interferometric methods is that they require measuring assemblies that are particularly sensitive to noise and vibrations.

Recently, three-dimensional inspection methods based on Moiré interferometry have been developed for a more accurate measurement of the object in the visible spectrum. These methods are based on the analysis of the frequency beats obtained between 1) a grid positioned over the object to be measured and its shadow on the object (“Shadow Moiré Techniques”) or 2) the projection of a grid on the object, with another grid positioned between the object and the camera that is used to photograph the resulting interferogram (“Projected Moiré Techniques”). In both cases, the frequency beats between the two grids produce the fringes of the resulting interferogram. On one hand, a drawback of the Shadow Moiré technique for measuring the relief of an object is that the grid must be very closely positioned to the object in order to yield accurate results, causing restrictions in the set-up of the measuring assembly. On the other hand, a drawback of the Projected Moiré technique is that it involves many adjustments, and therefore generally produces inaccurate results since it requires the positioning and tracking of the two girds; furthermore, the second grid tends to obscure the camera, preventing it from being used simultaneously to take other measurements.

Interestingly, methods based on “phase-shifting” interferometry allow measurement of the relief of an object by analyzing the phase variations of a plurality of images of the object after projections of a pattern thereto. Each image corresponds to a variation of the position of the grid, or of any other means producing the pattern, relative to the object. Indeed, the intensity I(x,y) for every pixel (x,y) on an interferometric image may be described by the following equation:

I(x,y)=A(x,y)+B(x,y)·cos (ΔΦ(x,y)) (1)

where Δφ is the phase variation (or phase modulation), and A and B are a coefficients that can be compute for every pixel.

In the PCT application No. WO 01/06210, entitled “Method And System For Measuring The Relief Of An Object”, Coulombe et al. describe a method and a system for measuring the height of an object using at least three interferometric images. Indeed, since Equation 1 comprises three unknowns, that is A, B and Δφ, three intensity values I₁, I₂ and I₃ for each pixel, therefore three images are required to compute the phase variation Δφ. Knowing the phase variation Δφ, the object height distribution 1 at every point z(x,y) relative to a reference surface 2 can be computed using the following equation:

$$z ( x , y ) = [ \frac{Δ φ ( x , y ) \cdot p}{2 π \cdot tan ( θ )} ] \qquad ( 2 )$$

where p is the grid pitch and θ is the projection angle, as described hereinabove and as illustrated in FIG. 1.

A drawback of such a system is that it requires moving the grid between each take of images, increasing the image acquisition time. This can be particularly detrimental, for example, when such a system is used to inspect moving objects on a production line. More generally, any moving parts in such systems increase the possibility of imprecision and also of breakage.

Moreover, such systems and method prove to be lengthy, in particular considering the time required for acquiring at least three images.

A method and a system for measuring the height of an object free of the above-mentioned drawbacks of the prior-art is thus desirable.

### OBJECTS OF THE INVENTION

An object of the present invention is therefore to provide an improved 3D height measurement method and system.

Other objects, advantages and features of the present invention will become more apparent upon reading of the following non-restrictive description of specific embodiments thereof, given by way of example only with reference to the accompanying drawings.

### SUMMARY OF THE INVENTION

More specially, in accordance with the present invention, there is provided a Fast Moiré Interferometry (FMI) method and system for measuring the dimensions of a 3D object using only two images thereof. The method and the system perform the height mapping of the object or the height mapping of a portion of the object with respect to a reference surface. The present invention can be used to assess the quality of the surface of an object that is under inspection. It can also be used to evaluate the volume of the object under inspection.

The method for performing a height mapping of the object with respect to a reference surface comprises obtaining a first intensity characterizing the object, the object on which is projected an intensity pattern characterized by a fringe contrast function M(x,y), and the intensity pattern being located at a first position relatively to the object; obtaining a second intensity characterizing the object, the object on which is projected the intensity pattern at a second position shifted from the first position; calculating a phase value characterizing the object using said intensities and said fringe contrast function M(x,y); and obtaining the height mapping of the object by comparing the phase value to a reference phase value associated to the reference surface.

The method can further comprise obtaining the height mapping of a portion of an object, the portion corresponding to a layer of the object.

The method can further comprise evaluating the volume of an object from its height mapping.

The method can further comprise determining a difference between the height mapping of object and a reference height mapping value, and using this difference to assess the quality of the object.

The system for performing a height mapping of the object with respect to a reference surface comprises a pattern projection assembly for projecting, onto the object, an intensity pattern characterized by a given fringe contrast function M(x,y); displacement means for positioning, at selected positions, the intensity pattern relative to the object; and a detection assembly for acquiring an intensity characterizing the object for each selected positions of said pattern relative to the object. Finally the system comprises computing means for calculating a phase value characterizing the object using the intensity acquired for each selected positions; and further determining the height mapping of the object by comparing the phase value to a reference phase value associated to the reference surface.

### BRIEF DESCRIPTION OF THE DRAWINGS

In the appended drawings:

FIG. 1, which is labeled prior art, is a schematic view of a phase-stepping profilometry system as known in the prior art;

FIG. 2 is a flowchart of a method for performing a height mapping of an object according to an embodiment of the present invention;

FIG. 3 is schematic view of the system for performing the height mapping of an object according to an embodiment of the present invention.

FIG. 4 is a block diagram describing the relations between the system components and a controller according to an embodiment of the present invention.

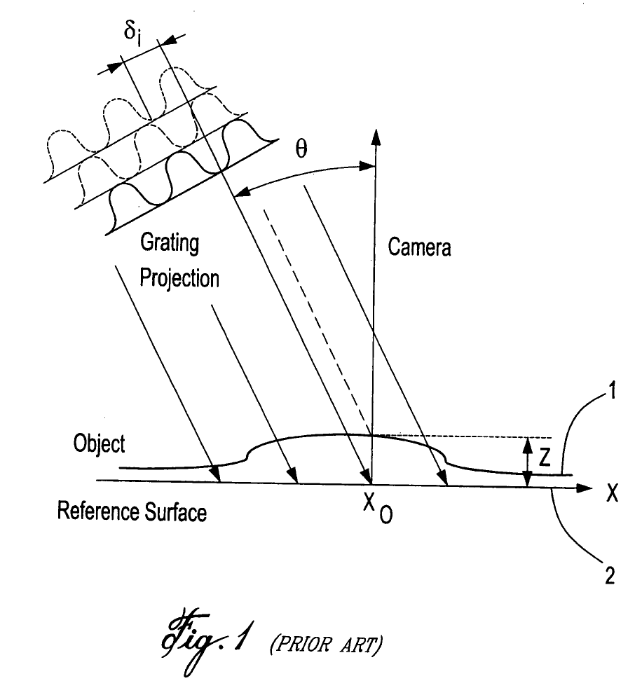

### DESCRIPTION OF THE SPECIFIC EMBODIMENT

Generally stated, the present invention provides a Fast Moiré Interferometry (FMI) method for measuring dimensions of a 3D object using only two images thereof. In the present embodiment we will focus on a phase-shifting profilometry method using visible light source and a digital camera to acquire those two images.

In the present embodiment, a grid pattern is projected onto an object 3 as illustrated in FIG. 3. Because of an angle θ between the projection and detection axes, the intensity of the projected grating varies both on horizontal (x) and vertical (z) direction. In the present embodiment the intensity of the projected grating onto the object corresponds to sinusoidal projected fringes, and can be described as follows:

I(x,y)=R(x,y)·[1+M(x,y)·Cos (kₓ·x+k_{y}y+k_{z}·z(x,y)+φ₀+δᵢ] (3)

where I(x,y) is the light intensity at the object coordinates {x,y}; R(x,y) is proportional to the object reflectance and light source intensity; M(x,y) is a fringe contrast function; kₓ, k_{y} and k_{z} are the fringe spatial frequencies near the target, φ₀ is a phase offset constant. By acquiring the intensity I(x,y) using for example a CCD camera, an image of the object can be obtained.

The FMI method is based on the difference of the phase value on an inspected φ_{target}(x,y) and referenced φ_{ref}(x,y) surfaces. This difference is usually calculated point by point and yields the object height mapping, z(x, y), for each point {x,y}:

φ_{target}(x,y)=kₓ·x+k_{y}·y+k_{z}·z_{target}(x,y)+φ₀ (4)

φ_{ref}(x,y)=kₓ·x+k_{y}·y+k_{z}·z_{ref}(x,y)+φ₀ (5)

$$z ( x , y ) = {z}_{target} ( x , y ) - {z}_{ref} ( x , y ) = \frac{1}{{k}_{z}} \cdot ( {ϕ}_{target} ( x , y ) - {ϕ}_{ref} ( x , y ) ) \qquad ( 6 )$$

where the coefficient k_{z} represents the spatial grating frequency in the z direction and can be obtained from system geometry or from calibration with an object of known height.

Then, a phase-shifting technique is applied in order to determine the phase values for each point φ(x,y). The phase-shifting technique consists in shifting the pattern relatively to the object in order to create a phase-shifted intensity I(x,y) or image. At least three different phase-shifted images, obtained with three phase-shifted projected patterns, are required in order to solve a system with 3 unknowns, namely R(x,y), M(x,y), and φ(x,y), yielding the phase value. For example, in a simple case of four phase steps of π/2 the system takes the following form:

$$\{ \begin{matrix}{I}_{a} ( x , y ) = R ( x , y ) \cdot [ 1 + M ( x , y ) \cdot Cos ( ϕ ( x , y ) ) ] \\ {I}_{b} ( x , y ) = R ( x , y ) \cdot [ 1 + M ( x , y ) \cdot Cos ( ϕ ( x , y ) + π / 2 ) ] \\ {I}_{c} ( x , y ) = R ( x , y ) \cdot [ 1 + M ( x , y ) \cdot Cos ( ϕ ( x , y ) + π ) ] \\ {I}_{d} ( x , y ) = R ( x , y ) \cdot [ 1 + M ( x , y ) \cdot Cos ( ϕ ( x , y ) + 3 π / 2 ) ]\end{matrix} \qquad ( 7 )$$

and can be resolved as follows:

$$ϕ ( x , y ) = {tg}^{- 1} [ \frac{{I}_{d} ( x , y ) - {I}_{b} ( x , y )}{{I}_{a} ( x , y ) - {I}_{c} ( x , y )} ] \qquad ( 8 )$$

The method of the present invention takes advantage of the fact that while the R(x,y) parameter is determined by lighting intensity, optical system sensitivity, and object reflectance, and therefore can vary during inspection of different object, on the contrary, the value of the fringe contrast function M(x,y) is determined only by fringe contrast (camera and projection system focusing), so that the M(x,y) function is a constant during inspection of different objects provided that the projected system is the same. Therefore, the method provides that function M(x,y) be preliminary measured, thereby allowing the elimination of an unknown in the equation (3) which thereafter reads as follows:

I(x,y)=R(x,y)·[1+M(x,y)·Cos (φ(x,y))] (9)

Therefore, the method of the present invention provides dealing with only two unknowns (see Equation (9)), namely R(x,y) and φ(x,y), thereby making it possible to use only two images to calculate the phase.

For example, using two images Iₐ(x, y) and I_{c}(x,y) that are shifted by π, the phase can be calculated as follow:

$$\begin{matrix}\{ \begin{matrix}{I}_{a} ( x , y ) = R ( x , y ) \cdot [ 1 + M ( x , y ) \cdot Cos ( ϕ ( x , y ) ) ] \\ {I}_{c} ( x , y ) = R ( x , y ) \cdot [ 1 + M ( x , y ) \cdot Cos ( ϕ ( x , y ) + π ) ]\end{matrix} & ( 10 ) \\ ϕ ( x , y ) = {cos}^{- 1} [ \frac{{I}_{a} ( x , y ) - {I}_{c} ( x , y )}{{I}_{a} ( x , y ) + {I}_{c} ( x , y )} \cdot \frac{1}{M ( x , y )} ] & ( 11 )\end{matrix}$$

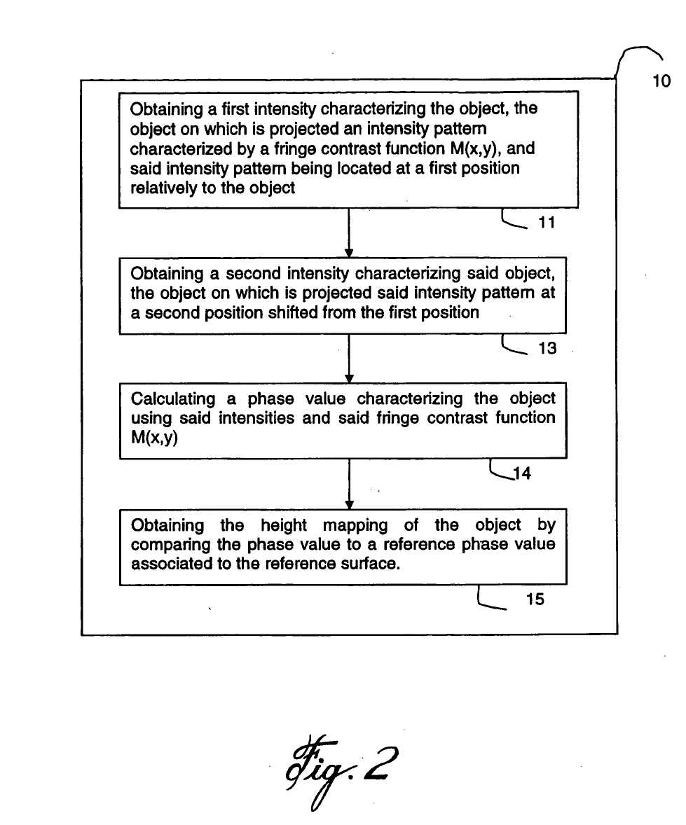

Although the above example is based on a phase-shifting of Π, the present method can be realized with any other phase-shifted value. Therefore, as illustrated in FIG. 2 of the appended drawings, a method 10 consisting in performing an height mapping of an object according to an embodiment of the present invention comprises obtaining a first intensity characterizing said object, the object on which is projected an intensity pattern characterized by a fringe contrast function M(x,y), and the intensity pattern being located at a first position relatively to the object, (step 11); obtaining a second intensity characterizing said object, the object on which is projected the intensity pattern at a second position shifted from the first position,(step 13); calculating a phase value characterizing the object using said intensities and said fringe contrast function M(x,y); (step 14); obtaining the height mapping of the object by comparing the phase value to a reference phase value associated to the reference surface (step 15). In particular, the height mapping z(x,y) can be computed using equation (6).

The measurement of the M(x,y) distribution can be performed during calibration of the measurement system 20 or by acquiring additional intensity values. For example, by acquiring the four intensity relations of equation (7) for an object, M(x,y) can be easily calculated.

The phase value that corresponds to a reference surface can be obtained by performing steps 11 to 14 for a reference object. It will be obvious for someone skilled in the art that this reference object can also be the object itself inspected at an earlier time, a similar object used as a model, or any kind of real or imaginary surface.

Persons skilled in the art will appreciate that the method of the present invention, by using only two images instead of at least three of them, allows for a faster acquisition and therefore for a faster object inspection. However, they will also appreciate that if, additional images are acquired, they can be advantageously used to increase the precision and the reliability of the method. By acquiring, for example, three or more images, it is possible to select among them the ones that are the more appropriate to perform the object height mapping. This way it is possible to discard according to a given criteria images or portions of images. For example, noisy pixels can be discarded and therefore the reliability of the method is improved. Alternatively, more than two intensity values can be used to compute the phase, that way improving the precision of the measurements

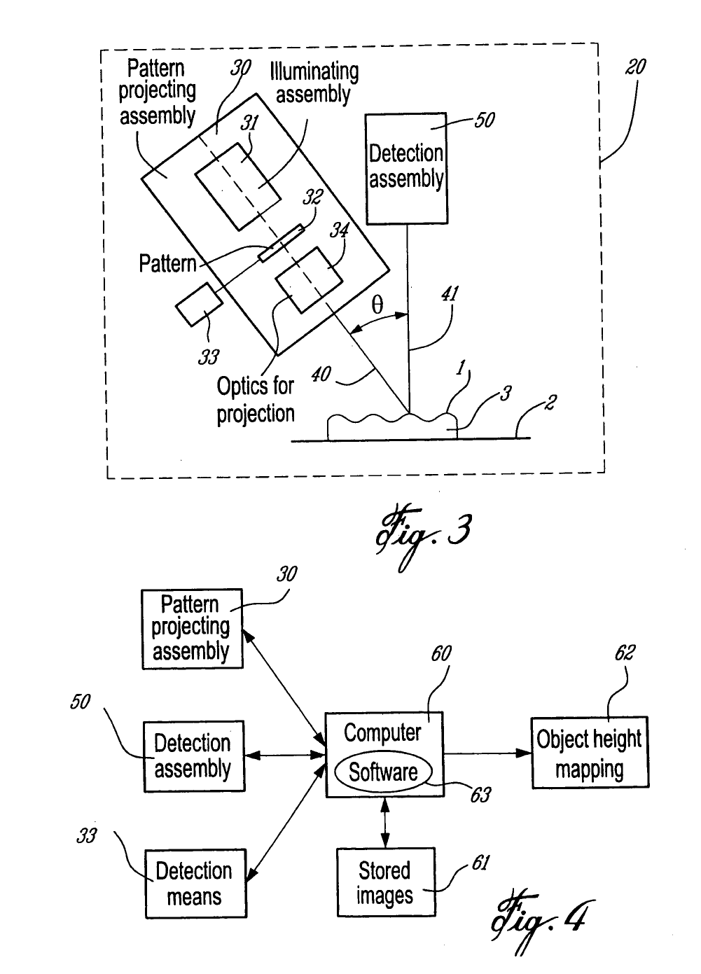

Turning now to FIGS. 3 and 4, a system 20 for performing a height mapping of the object, according to an embodiment of the present invention, is shown. In FIG. 3, a pattern projection assembly 30 is used to project onto the surface 1 of the object 3 an intensity pattern having a given fringe contrast function M(x,y). A detection assembly 50 is used to acquire the intensity values that have been mathematically described by equation (10). The detection assembly 50 can comprise a CCD camera or any other detection device. The detection assembly 50 can also comprise the necessary optical components, known to those skilled in the art, to relay appropriately the projected intensity pattern on the object to the detection device. The pattern projection assembly 30 is projecting the intensity pattern at an angle θ with respect to the detection axis 41 of the detection assembly, where the angle θ is the angle appearing in equation (2). The pattern projection assembly can comprises, for example, an illuminating assembly 31, a pattern 32, and optics for projection 34. The pattern 32 is illuminated by the illuminating assembly 31 and projected onto the object 3 by means of the optics for projection 34. The pattern can be a grid having a selected pitch value, p. Persons skilled in the art will appreciate that other kinds of patterns may also be used. The characteristics of the intensity pattern can be adjusted by tuning both the illuminating assembly 31 and the optics for projection 34. The pattern displacement means 33 is used to shift, in a controlled manner, the pattern relatively to the object. The displacement can be provided by a mechanical device or could also be performed optically by translating the pattern intensity. This displacement can be controlled by a computer 60. Variants means for shifting the pattern relative to the object include displacement of the object 3 and displacement of the pattern projection assembly 30.

As illustrated in FIG. 4, the computer 60 can also control the alignment and magnification power of the pattern projection assembly and the alignment of the detection assembly 50. Naturally the computer 60 is used to compute the object height mapping from the data acquired by the detection assembly 50. The computer 60 is also used to store acquired images and corresponding phase values 61, and manage them. A software 63 can act as an interface between the computer and the user to add flexibility in the system operation.

The above-described method 10 and system 20 can be used to map the height of an object with respect to a reference surface or to compute the relief of an object. They may also be provided for detecting defects on an object in comparison with a similar object used as a model or to detect changes of an object surface with time. In all cases, the above-described method 10 and system 20 can further include the selection of an appropriate intensity pattern and of an appropriate acquisition resolution that will be in accordance with the height of the object to be measured.

The above-described method 10 can naturally be applied in discrete steps in order to perform the height mapping of the object layer by layer. This technique—also called image unwrapping—enables one to measure the net object height mapping while keeping a good image resolution. The above-described method 10 and system 20 can also be used to determine the volume of an object or the volume of part of an object, since the object height mapping contains information, not only about the height of the object, but also about its length and width. This method can be advantageously applied, for example, in the semiconductor industry to determine the volume of some components parts that are under inspection such as, for example, connecting leads, and from that volume inferred the quality of the component part.

All the above presented applications of the invention can be used to further assess the quality of an object under inspection by comparing, when the object surface is inspected, the height mapping of the object to a reference height mapping, or, by comparing, when the object volume is under inspection, the volume of the object obtained from its height mapping to a know volume value.

The system 20 offers also the possibility to acquire an image of the object corresponding to a situation where the object is illuminated without any pattern. This image, thereafter referred to as a unpattern image, can be obtained by adding the two intensities Iₐ(x,y) and I_{c}(x,y), I_{c}(x,y) being phase-shifted by π with respect to Iₐ(x,y). It will be obvious for someone skilled in the art that the unpattern image can also be obtained by acquiring other combination of intensities. This unpattern image can be used for example as a preliminary step in assessing the quality of an object or as an additional tool during the object inspection.

Although the present invention has been described hereinabove by way of specific embodiments thereof, it can be modified, without departing from the spirit and nature of the subject invention as defined herein.

What is claimed is:

1. A method for performing a height mapping of an object with respect to a reference surface, the method comprising the steps of:
obtaining a first intensity characterizing said object, said object on which is projected an intensity pattern characterized by a fringe contrast function M(x,y), and said intensity pattern being located at a first position relatively to the object;
obtaining a second intensity characterizing said object, said object on which is projected said intensity pattern at a second position shifted from said first position;
calculating a phase value characterizing the object using said intensities and said fringe contrast function M(x,y);
obtaining the height mapping of the object by comparing the phase value to a reference phase value associated to the reference surface.

2. The method as claimed in claim 1, wherein said obtaining said intensities comprises projecting said intensity pattern onto said object and measuring said intensities.

3. The method as claimed in claim 1, wherein said height mapping comprises the relief of the object.

4. The method as claimed in claim 1, wherein said reference phase value comprises a phase value generated from the extrapolation of a portion of the phase value characterizing the object.

5. The method as claimed in claim 1, wherein said reference phase value comprises a computer generated virtual phase value.

6. The method as claimed in claim 1, wherein said reference surface corresponds to a model object similar to said object, and further wherein said obtaining the height mapping comprises detecting defects between said model object and said object.

7. The method as claimed in claim 1, wherein said object is the object at time t and said reference surface is the object surface at a previous time t-T, and further wherein said obtaining the height mapping comprises detecting the variation of the object surface with respect to time.

8. The method as claimed in claim 1, wherein said intensity characterizing the object comprises visible light intensity.

9. The method as claimed in claim 1, wherein said intensity pattern comprises a sinusoidal pattern.

10. The method as claimed in claim 1, wherein the shift in said second position comprises a 90 degrees shift from said first position.

11. The method as claimed in claim 1, wherein the shift in said second position comprises a 180 degrees shift from said first position.

12. The method as claimed in claim 11 further comprising adding said first and second intensity thereby obtaining an image of said object without said pattern.

13. The method as claimed in claim 1 further comprising projecting said intensity along a projection axis that is inclined at an angle θ relatively to a detection axis, wherein said detection axis is the direction along which said first and second intensities are obtained.

14. The method as claimed in claim 1 further comprising choosing the intensity pattern in accordance with the height of the object to thereby obtain the height mapping of the whole object.

15. The method as claimed in claim 14 wherein said choosing comprises adjusting an angle θ between a projecting axis and a detection axis, wherein said projecting axis is parallel to the direction along which said intensity pattern is projected, and wherein said detection axis is parallel to the direction along which said first and second intensities are acquired.

16. The method as claimed in claim 1 wherein said obtaining said first and second intensities comprises providing an acquisition resolution in accordance with a desired height mapping of the object.

17. The method as claimed in claim 1 further comprising obtaining the height mapping of a portion of said object, said portion corresponding to an object layer.

18. The method as claimed in claim 1 further comprising obtaining at least another intensity characterizing said object, said object on which said intensity pattern is projected at at least another position shifted from said first and second positions.

19. The method as claimed in claim 18 further comprising selecting, among said first intensity, said second intensity, and said at least another intensity, at least two intensities.

20. The method as claimed in claim 19, wherein said selecting comprises choosing portions of said intensities.

21. The method as claimed in claim 19 wherein said selecting comprises choosing intensities according to at least one given criteria.

22. The method as claimed in claim 20 wherein said selecting comprises choosing at least one of said intensities and said portions of said intensities according to at least one given criteria.

23. The method as claimed in claim in claim 19 wherein said obtaining further comprises averaging said intensities.

24. The method as claimed in claim 19 further comprising adding said selected intensities thereby obtaining an image of said object without said pattern.

26. The method as claimed in claim 1 further comprising:
determining a difference between said height mapping of the object and a reference height mapping value;
using said difference to assess a quality of said object.

27. The method as claimed in claim 1 further comprising evaluating the volume of said object from said height mapping.

28. The method as claimed in claim 27 further comprising:
determining a difference between said object volume and a reference volume;
using said difference to assess a quality of said object.

29. A system for performing a height mapping of an object with respect to a reference surface, the system comprising:
a pattern projection assembly for projecting, onto the object, an intensity pattern characterized by a fringe contrast function M(x,y);
displacement means for positioning, at selected positions, said intensity pattern relative to said object;
a detection assembly for acquiring an intensity characterizing said object for each selected positions of said pattern relative to said object;
computing means for calculating a phase value characterizing the object using said intensity acquired for said each selected positions; and further determining the height mapping of the object by comparing the phase value to a reference phase value associated to the reference surface.

30. The system as claimed in claim 29, wherein said pattern projection assembly comprises an illuminating assembly, a pattern, and optical elements for providing said intensity pattern.

31. The system as claimed in claim 29 wherein said detection assembly comprises a detection device and optical devices for acquiring said intensity characterizing said object.

32. The system as claimed in claim 29, wherein said detection assembly comprises a CCD camera.

33. The system as claimed in claim, wherein said displacement means comprises a mechanical displacement device.

34. The system as claimed in claim 29, wherein said computing means comprises a computer.

35. The system as claimed in claim 29 further comprising a controller for controlling at least one of said pattern projection assembly, said displacement means, said detection assembly, or said computing means.

36. The system as claimed in claim 29 further comprising storage means for storing, as images, at least one of said intensity characterizing said object, said phase value characterizing said object, and said reference value.

37. The system as claimed in claim 36 further comprising managing means for managing said images.

38. The system as claimed in claim 35, wherein said controller comprises adjusting characteristics of said intensity pattern.

39. The system as claimed in claim 35, wherein said controller comprises adjusting the positioning of said intensity pattern relative to said object.

40. The system as claimed in claim 35, wherein said controller comprises adjusting the shifting of said intensity pattern from a previous position relative to said object to a desired position relative to said object, wherein said object is at a fixed position.

41. The system as claimed in claim 35 wherein said controller comprises controlling the optical characteristics of said detection assembly.

42. The system as claimed in claim 35 further comprising an interface to manage said controller system.

43. The system as claimed in claim 35 further comprising storage means for storing, as images, at least one of said intensity characterizing said object, said phase value characterizing said object, and said reference value.

44. The system as claimed in claim 43 further comprising managing means for managing said images.
